(19) United States
(12) Patent Application Publication
(10) Pub. No.: US 2013/0027816 A1
(43) Pub. Date: Jan. 31, 2013

(54) SUPRACONDUCTIVE COIL TRANSITION DETECTOR

(71) Applicants: Arnaud Badel, Unieux (FR); Pascal Tixador, Grenoble (FR)

(72) Inventors: Arnaud Badel, Unieux (FR); Pascal Tixador, Grenoble (FR)

(73) Assignee: CENTRE NATIONAL DE LA RECHERCHE SCIENTIFIQUE, Paris Cedex 16 (FR)

(21) Appl. No.: 13/579,333

(22) PCT Filed: Feb. 15, 2011
(86) PCT No.: PCT/FR2011/050318

§ 371 Date: Oct. 22, 2012

(30) Foreign Application Priority Data
Feb. 17, 2010 (FR) 1000663

(51) Int. Cl. H02H 7/00

(52) U.S. Cl. 361/19

(57) ABSTRACT

The invention relates to a supraconductive coil transition detector comprising means for disconnecting the detector directly before a coil discharge phase. The detector comprises a resistive divider (R1, R2) arranged in parallel on the supraconductive coil (1), the middle point A of the supraconductive coil and the middle point (B) of the resistive divider being connected to the two inlets of a threshold comparator. The connection means comprise switches (31-33) arranged on the connections between the coil and the detector, and means for opening said switches as soon as the comparator supplies a signal above a threshold.

### BACKGROUND

The present disclosure relates to superconducting coils of high or low critical temperature submitted to high voltages, during their normal use and/or during their discharge in case of a quench.

The present disclosure more specifically relates to the detection of quenches for the protection of such coils.

### DISCUSSION OF THE ART

As known, there is a risk for a quench, that is, the passing to a non-superconducting state, to occur at a point of a superconducting coil. A strong heat dissipation then occurs in the portion which is no longer superconducting and the coil risks being damaged. This problem is aggravated in case a super-conductive material having a high critical temperature, and/or if the power available for the cooling is limited.

A solution to protect the winding is to detect such a local quench and to then very quickly discharge the coil before it can be destroyed. The current discharge must be as fast as possible to limit the amount of power dissipated in the form of heat in the area where the transition occurs. To achieve this, the highest possible discharge voltage must be reached. Voltages of several kV are current, and they can even reach several tens of kV in very large systems.

FIG. 1 shows a circuit diagram of a superconducting coil 1 used as a current pulse generator. This coil is powered by a power source 3 via high voltage switches such as electromechanical relays 5a and 5b. A load 7 is arranged in parallel on the coil. Thus, when switches 5a, 5b are on, the coil is charged by power source 3. When switches 5a, 5b are turned off, the coil discharges into load 7.

To detect a local quench, a detection system of the type illustrated in FIG. 1 may be used.

A dividing bridge 8, for example formed of two resistors R1, R2 belonging to a potentiometer, is arranged in parallel on the coil and the voltage of midpoint A of the coil and junction point B of the resistors is compared. Normally, this voltage is zero. However, if a state transition occurs at one point of the coil, the bridge formed by the half-coils and the two resistors R1, R2 becomes imbalanced. The imbalance is detected by a threshold comparator 9 having its output delivered to a processing stage 11. Processing stage 11 delivers, as soon as comparator 9 has detected an imbalance, a control signal on an output 13 for switches 5a and 5b, which are then turned off to discharge the coil. It should be noted that circuit 11 may also comprise an external control input 15, intended to control the coil discharge when desired.

This circuit operates satisfactorily if midpoint A of the coil is connected to the same reference as all the detection and processing circuits, that is, generally, the ground. Otherwise, as soon as the discharge begins, the very high voltage appearing across the coil is capable of destroying elements of the detection and processing circuit.

Connecting the middle of the coil to a reference potential is disturbing for two reasons. First, this imposes a reference to the power circuit, which is an inconvenience for the forming of an assembly of several coils (need to have independent sources) and limits the flexibility of use of the power stored in the coil in the case of a use thereof as a current source. Further, referencing the middle of the coil to ground is dangerous since, in the case of a poor isolation of the winding, this causes the occurrence of a ground loop in which an uncontrolled current may flow. It is thereby necessary to arrange a fuse on the midpoint connection. This fuse suppresses the reference in case of a defect, which, although it protects the coil, does is to the detriment of the protection system, which can then have the discharge voltage between its terminals and thus risks being destroyed.

To overcome this disadvantage, the circuit of FIG. 2, which comprises the same elements as that of FIG. 1, designated with the same reference numerals, but with the addition of elements of protection between the coil and the detection and processing circuit, has been provided. Such protection elements are designated in FIG. 2 with reference numerals 21 and 23. More specifically, such systems are described in an article by D. Birus et al “Development of Quench Detection System for W7-X” published Fusion Engineering and Design 82 (2007), pp. 1400-1405, in an article by Yukikazu Iwasa “Protection of HTS magnets” published in Physica C 426-431 (2005), pp. 1348-1352and in an article by J. Schultz “Protection of Superconducting Magnets” published in IEEE Transactions on Applied Superconductivity, vol. 12, N°1, March 2002. In Birus's article, elements 21 and 23 are formed of high-voltage optoelectronic couplers. In Iwasa's article, no specific protection element is provided but it is indicated that a difficult problem is posed due to the very low imbalance voltage which is desired to be detected. Schultz et al.'s article provides using voltage dividers.

All these solutions have various disadvantages. They use either expensive couplers, which are poorly adapted to very high voltage systems, or voltage dividers. Voltage dividing systems have the disadvantage that, given that a very strong voltage division must be performed to protect the detection circuit from voltages on the order of several kilovolts, the wanted signal becomes very difficult to distinguish from the background noise and very sophisticated detection systems should be used.

### SUMMARY

The present invention aims at overcoming at least certain disadvantages of prior art devices.

More specifically, the present invention provides a simple system of local quench detection in a superconducting coil protected against very high voltages capable of appearing across the coil, for example, during discharge periods of this coil.

Thus, an embodiment of the present invention provides a superconducting coil quench detector comprising means for disconnecting the detector as soon as a quench is detected.

According to an embodiment of the present invention, the detector comprises means for starting a coil discharge phase immediately after the detection of a quench by the detector.

According to an embodiment of the present invention, a resistive divider is arranged in parallel on the superconducting coil, the midpoint of the superconducting coil and the midpoint of the resistive divider being connected to the two inputs of a threshold comparator.

According to an embodiment of the present invention, the disconnection means comprise switches arranged on the connections between the coil and the detector and means for turning off these switches as soon as the comparator provides a signal greater than a threshold.

According to an embodiment of the present invention, the disconnection means comprise switches arranged on each of the connections towards the high point, the low point, and the midpoint of the superconducting coil.

According to an embodiment of the present invention, the detector further comprises means for offsetting the output voltage of the midpoint of the resistive bridge when the superconducting coil is submitted to a field variation due to another coil.

According to an embodiment of the present invention, the disconnection means are reed relays.

### BRIEF DESCRIPTION OF THE DRAWINGS

The foregoing and other objects, features and advantages of the present invention will be discussed in detail in the following non-limiting description of specific embodiments in connection with the accompanying drawings, among which:

FIG. 1, previously described, shows a superconducting coil quench detection circuit;

FIG. 2, previously described, shows a protected superconducting coil quench detection circuit;

FIG. 3 shows a protected superconducting coil quench detection circuit according to an embodiment of the present invention; and

FIG. 4 shows a protected superconducting coil quench detection circuit adapted to a system comprising two sets of superconducting coils, according to an embodiment of the present invention.

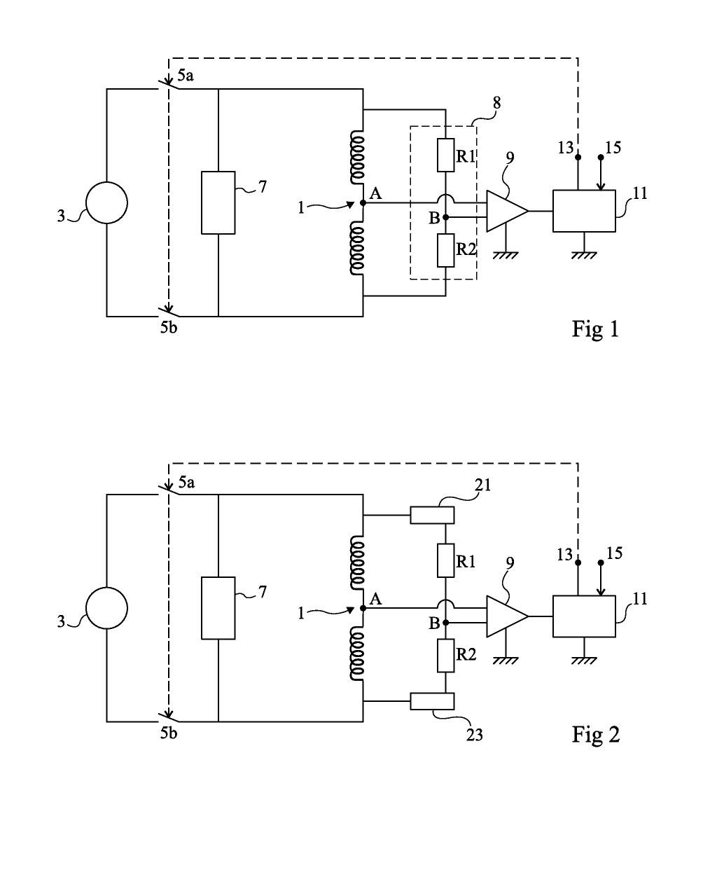

### DETAILED DESCRIPTION

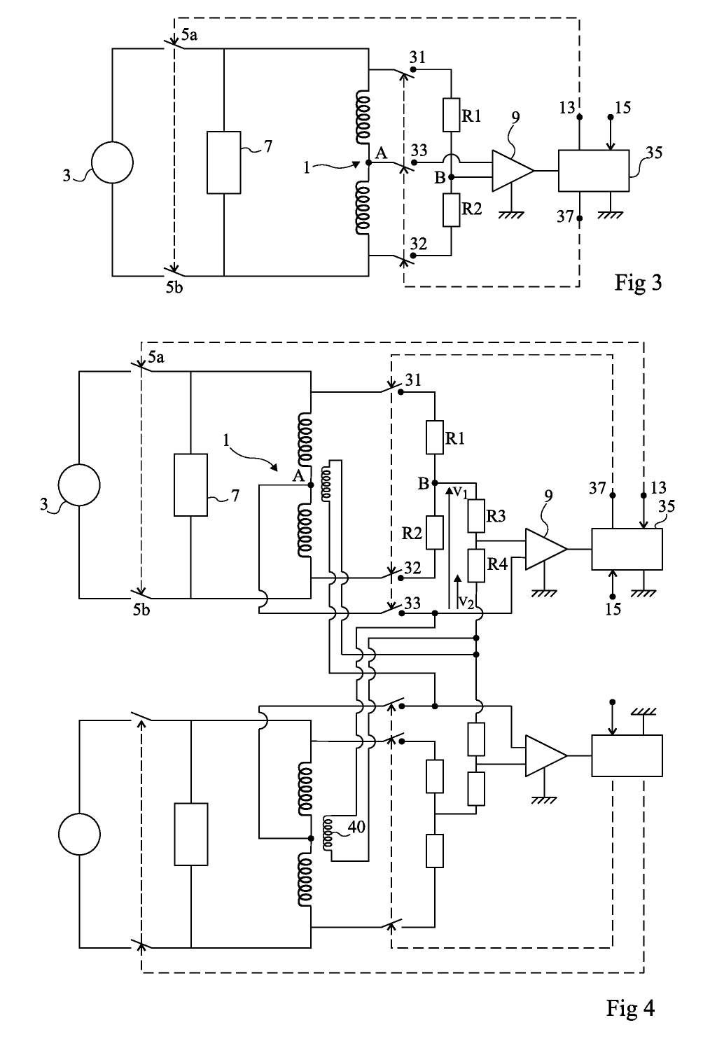

In the circuit of FIG. 3, the same elements as in the circuit of FIG. 1 have been shown with the same reference numerals and will not be described again.

Controlled relays 31, 32, and 33 are inserted on the connections respectively leading to the high, low, and mid-points of the coil between the power circuit and the detection and processing circuit. In the shown example, such relays are arranged at the inputs of threshold comparator 9. Processing circuit 11 is replaced with a processing circuit 35 further comprising an output 37 capable of controlling the turning-off of relays 31-33, which for example are reed relays, as soon as a voltage imbalance of a few millivolts is detected between the two halves of the superconducting coil. The signal on terminal 37 intended to open relays 31 and 33 is provided a few moments (a few microseconds) before the provision of a signal on terminal 13 to open main relays 5a and 5b of the power circuit.

Due to this disconnection, as soon as a voltage imbalance is detected, the detection and processing circuit is fully isolated from the high voltages capable of appearing on the coil on discharge thereof and a simple detection and processing circuit which is not specifically protected can then be used. Further, this circuit does not need to be particularly desensitized to noise since it detects, with no division, the entire voltage difference present between the two halves of the superconducting coil when said coil is in normal operation (outside of discharge periods).

FIG. 4 illustrates the case of a system comprising two sets of superconducting coils close to each other and shows how to protect the detection circuits with controlled switches, as shown hereabove, without for the discharge of a first superconducting coil to cause the concurrent discharge of the second superconducting coil.

The problem is that, when two superconducting coils are arranged close to each other, the variation of the field generated by the first coil has an influence on the second coil. This influence is asymmetrical and mainly acts on the portions of the second coil located close to the first coil. As a result, the detector associated with the second coil risks detecting a voltage variation between the two halves of the second coil and, accordingly, causing the discharge of the second coil, which is not desired.

In FIG. 4, only the elements corresponding to the upper portion of the drawing and to the first coil are designated with reference numerals. The lower portion of the drawing is strictly identical to the upper portion and is symmetrical thereto. Further, the elements of the upper portion of the drawing similar to those described in relation with FIG. 3 are designated with the same reference numerals.

Each detector comprises, in addition to the already-described elements, a modification of the connection of junction point B of resistors R1 and R2. Node B, instead of being directly connected to an input of threshold comparator 9, is connected thereto via a dividing bridge R3, R4. Resistor R3 is connected to node B, the junction of resistors R3 and R4 is connected to the input of the threshold comparator, and the second terminal of resistor R4 is connected to a terminal of a detection inductance 40 arranged in the lower assembly of FIG. 4. The other terminal of detection coil 40 is connected to the midpoint of junction 1 and to the second input of threshold comparator 9.

Thus, if the lower coil is in a discharge state and exerts an influence on the lower portion of the upper coil, while switches 31-33 of the upper assembly are on, a voltage v1 develops between nodes A and B. This voltage is due to the field variation caused by the discharge of the lower coil and is detected by coil 40 which applies a voltage v2 between the reference terminal of comparator 9 and the lower terminal of resistor R4. Voltages v1 and v2 resulting from a same phenomenon can be adjusted, by adjusting the values of the detection coils and/or the values of resistors R3 and R4 to compensate for each other, so that, on the upper side, no voltage variation is detected.

Specific embodiments of the present invention have been previously described. Of course, various modifications and variations will occur to those skilled in the art, especially as concerns the forming of the dividers and the forming of the various switches. It should in particular be noted that a superconducting coil is generally formed of an assembly of coil elements. Further, the circuit diagrams provided herein are very simplified. Conventionally, additional elements may be added by those skilled in the art.

Although superconducting coils used in current pulse generators have been more specifically described, it should be noted that the present invention generally applies to the detection of quenches in superconducting coils and to the protection thereof.

1. A superconducting coil quench detector comprising disconnection means for disconnecting the coil detector as soon as a quench is detected.

2. The detector of claim 1, comprising means for starting a coil discharge phase immediately after the detection of a quench by the detector.

3. The detector of claim 1, comprising a resistive divider in parallel on the superconducting coil, the midpoint of the superconducting coil and the midpoint of the resistive divider being connected to the two inputs of a threshold comparator.

4. The detector of claim 3, wherein the disconnection means comprise switches arranged on the connections between the coil and the detector and means for turning off these switches as soon as the comparator provides a signal greater than a threshold.

5. The detector of claim 3, wherein the disconnection means comprise switches arranged on each of the connections towards the high point, the low point, and the midpoint of the superconducting coil.

6. The detector of claim 3, further comprising means for offsetting the output voltage of the midpoint of the resistive bridge when the superconducting coil is submitted to a field variation due to another coil.

7. The detector of claim 3, wherein the disconnection means are reed relays.
